(19) United States
(12) Patent Application Publication
(10) Pub. No.: US 2019/0082701 A1
(43) Pub. Date: Mar. 21, 2019

(54) RICE NOODLE MANUFACTURING APPARATUS

(71) Applicants: Myung Sang KIM, Seoul (KR); Young Hwang KWON, Seoul (US)

(72) Inventors: Myung Sang KIM, Seoul (KR); Young Hwang KWON, Seoul (US)

(21) Appl. No.: 16/304,269

(22) PCT Filed: May 19, 2017
(86) PCT No.: PCT/KR2017/005209

§ 371 Date: Nov. 23, 2018

(30) Foreign Application Priority Data
May 23, 2016 (KR) 10-2016-0062753

(51) Int. Cl. A21C 11/22; A21C 1/06; A21C 1/14; A23L 7/109; A23L 5/10

(52) U.S. Cl. CPC A21C 11/22; A21C 1/06; A23V 2002/00; A23L 7/109; A23L 5/13; A21C 1/1465

(57) ABSTRACT

An apparatus for manufacturing rice noodles has a mixing part formed as a box having a hollow part to accommodate and discharge paste where rice flour and water are mixed; a noodle forming part for dividing, into a plurality of parts, the paste discharged from the mixing part and discharging the same, and having a plurality of blades; a conveying part for conveying the paste and the noodles through the mixing part, the noodle forming part, and the heating part, to a point at which the noodles fall to a noodle collecting part; the noodle collecting part for collecting the conveyed noodles; a power part having a power motor and a power transmission part to provide the power required for each component; a control part for operating the power part and controlling the heat of the heating part; and the main body for supporting the constituent elements.

### 1. TECHNICAL FIELD

The present disclosure relates to a manufacturing apparatus for rice noodles, and more particularly, to the rice noodle manufacturing apparatus producing wet-type rice noodles with a wet dough employing tension of water, not cutting the dough after cooling.

### 2. BACKGROUND

In the conventional method of producing rice noodles, the dry method is dominant in that the amount of rice flour for dough is much higher than the moisture content. If the dough is processed with low moisture and high densities and then the dough is compressed by a roll or like a cold noodle (i.e., naengmyeon) to make the noodle, it can not sufficiently reflect the original characteristics of the rice noodles, stickiness and freshness as wet noodles.

Also, when manufacturing noodles with rice flour, the high viscosity of the rice flour compared to wheat flour makes it difficult to use so-called dry-process equipment, such as a kneader and an extruder used in conventional noodle making equipment.

In addition, the conventional noodle making method includes a cutting process with a blade after cooling subsequent to kneading process. However, it is very frequently occur the case where the kneaded dough is adhered to the blade due to the viscosity or the noodles are tangled after the cutting.

Patent documents referred to as prior arts include Korean Patent Registration No. 10-0851360, Korean Utility model Registration No. 02-0447704, and Korean Utility model Publication No. 20-1996-0002260.

### SUMMARY

The rice noodle manufacturing apparatus according to the present disclosure is characterized in that, in the case of producing wet rice noodles, a highly viscous and chewy noodle is provided by using a wet dough which can not be realized by a conventional dry noodle preparation method. It is an object of the present disclosure to provide a device for automatically performing a series of processes from dough to noodle production, in which the problems that arise when cutting after cooling can be overcome by processing the kneaded dough to noodles before cooling.

The rice noodle manufacturing apparatus of the present disclosure comprises a mixing unit (10) formed as a box having a hollow part therein for receiving a mixture containing rice flour and water and discharging a dough,

a noodle shaping unit (20) having a plurality of blades for shaping the discharged dough into a plurality of strands of noodle when the dough moves to the heating unit along the transfer belt (41),

a heating unit (30), which forms a box as a housing so that heat is not discharged to the outside of the box and heats the noodle in the inside of the box with steam when it passes through the box,

a transfer unit (40) for transferring the dough and the noodle passing through the mixing unit, noodle shaping unit and the heating unit to the point of dropping toward the following noodle collecting unit,

a noodle collecting unit (50) for collecting the dropped noodle after the transfer,

a power unit (60) having a motor (61) and a transmission unit (62),

a control unit (70) for controlling the operation of the power unit and the heat of the heating unit, and

a main body (80) for supporting all the components.

The mixing unit (10) includes

a mixing vane (11) equipped in the hollow part for mixing the rice flour with water, and comprising a plate-shaped rotating wing and a rotating shaft,
a mixing gear (12) formed outside of the mixing vane (11) extending from the rotating shaft of the mixing vane, and receiving the power from the power unit (60), and
a mixing discharge unit (14) formed at the lower end of the mixing housing for discharging the mixed dough toward the noodle shaping unit (20).

The noodle shaping unit (20) includes a dough dispenser (21) comprised of a dough supply port (211), which is formed on the back surface to receive the dough and connected to the mixing discharge unit (14), a dough container (212), which receives the supplied dough, and a plurality of dispensing outlets (213), which are formed in parallel on the floor in order to distribute the dough in a plurality of strands; and a noodle shaping knife (22) for shaping the dough into a noodle during the transfer process, and the noodle shaping knife is coupled to the front surface of the dough dispenser 21 and is comprised of a plurality of noodle shaping blades 221 which are formed corresponding to the number and position of the dispensing oullets (213), and a blade base (222), which is for supporting the noodle shaping blades. In addition, the blades (221) is formed with a shaping guide (2211) recessed in a U-shape when viewed from the bottom so that a cross section of the noodle can be gently formed at the lower end of the outer edge.

The heating unit (30) includes a heating unit housing (31) and a heating unit cover 32 to receive water for applying steam and to protect heat of the inside of the heating unit 30 from the outside. The heating unit housing 31 is formed so as to surround the transfer unit 40 and comprised of a noodle entrance port (311) toward the mixing unit 10 for entering the shaped noodle and the transfer belt 41, and a noodle discharge port 312 for discharging the noodle in a direction opposite to the entrance. A heating line 33 is formed on the inner bottom of the heating unit housing 31.

The heating unit housing 31 may further include a water outlet 313 at a lower end thereof.

The transfer unit 40 is constituted by a conveyor belt system including a transfer belt 41 and a transfer roller 42. One end of the transfer belt is extended by the axis of the roller so that a transmission gear 43 is further formed for receiving the power of the power unit 60.

In addition, it is characterized in that the transfer belt 40 is made of the Teflon material or its surface contacting the noodle is made of the Teflon-coated material.

For safety, the power unit 60 further includes a power transmission unit 62 and a power transmission housing 63 for receiving gears connected to the power transmission unit.

The main body 80 is made of a steel frame and includes a plurality of pillars 81 for supporting the apparatus in the longitudinal direction, beams 82 for supporting the apparatus in the transverse direction, and a caster (83) at the bottom for moving the apparatus easily.

The apparatus according to the present disclosure further includes a second transfer unit 90 installed below the above transfer unit for transferring the dropped noodle in the opposite direction, which comprises a second transfer belt (91) and a second transfer roller (92) in a conveyer belt system, wherein the axis of the roller extends so that one end of the belt further includes a second transfer gear 93 for receiving the power from the power unit.

It is characterized in that the second transfer belt is made of the Teflon material or its surface contacting the noodle is made of Teflon-coated material.

Also, the apparatus further comprises a belt oil supply unit 100, in which is provided below the second transfer belt, and comprising a belt oil chamber 101 in the form of a bowl for receiving oil, and a belt oil roller (102) installed between the belt (51) and the belt oil chamber (101) for supplying oil under the lower surface of the second transfer belt while rotating.

In addition, the apparatus further includes the planetary oil supply unit 110 which is installed below the inner end of the second transfer unit 50 and includes a noodle oil chamber 111 in the form of a bowl for receiving oil, and a noodle oil roller 112 installed between the noodle falling from the second transfer part (50) and the noodle oil case (111) for applying oil to the surface of the falling surface while rotating.

The apparatus according to the present disclosure makes it possible to provide a highly viscous and chewy texture of rice noodle, which is difficult to be realized by the conventional dry-noodle producing method, by use of a new wet-method of passing a watery dough through a heating process and a cooling process.

In addition, by employing the method shaping the noodle in the process of transferring the dough, it is possible to solve various problems caused by the conventional cutting method such as the dough and noodle entanglement.

This invention has the advantages in that since the heating and cooling are automatically performed during the kneading process through the noodle gathering process, the labor force of the worker can be minimized to increase the productivity, all the operations can be completed in one device, and the apparatus can be easily moved and stored by utilizing the caster.

### THE BRIEF DESCRIPTION OF THE DRAWINGS

FIG. 1 is a perspective view showing an embodiment of a rice noodle manufacturing apparatus according to the present disclosure;

FIG. 2 is a perspective view illustrating the mixing unit according to the present disclosure in detail;

FIG. 3 is a detailed view of the installation state of the noodle shaping unit according to the present disclosure;

FIG. 4 is a perspective view illustrating the noodle shaping unit according to the present disclosure in detail;

FIG. 5 is a plan perspective view showing a dough dispenser according to the present disclosure;

FIG. 6 is a rear perspective view showing a kneading dispenser according to the present disclosure;

FIG. 7 is a rear perspective view showing the back side of the noodle shaping knife according to the present disclosure,

FIG. 8 is a partially enlarged view for explaining a noodle shaping process according to the present disclosure;

FIG. 9 is a side perspective view illustrating the heating unit and the transmission unit according to the present disclosure;

FIG. 10 is a planar cutaway view of a heating part taken along line B-B in FIG. 9 according to the present disclosure,

FIG. 11 is a rear view of the rice noodle manufacturing apparatus according to the present disclosure;

FIG. 12 is a front view showing another embodiment of the rice noodle manufacturing apparatus according to the present disclosure.

### DETAILED DESCRIPTION

Preferred embodiments of a rice noodle manufacturing apparatus according to the present disclosure will now be described with reference to the drawings.

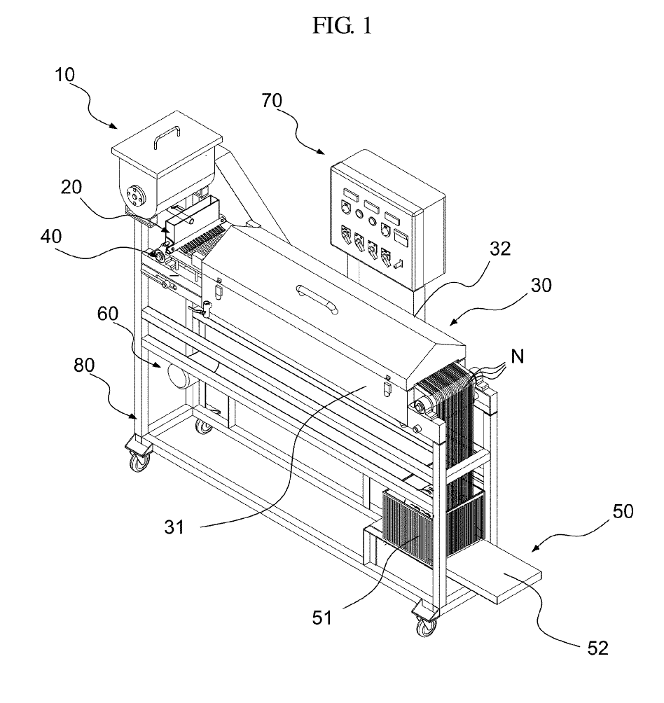

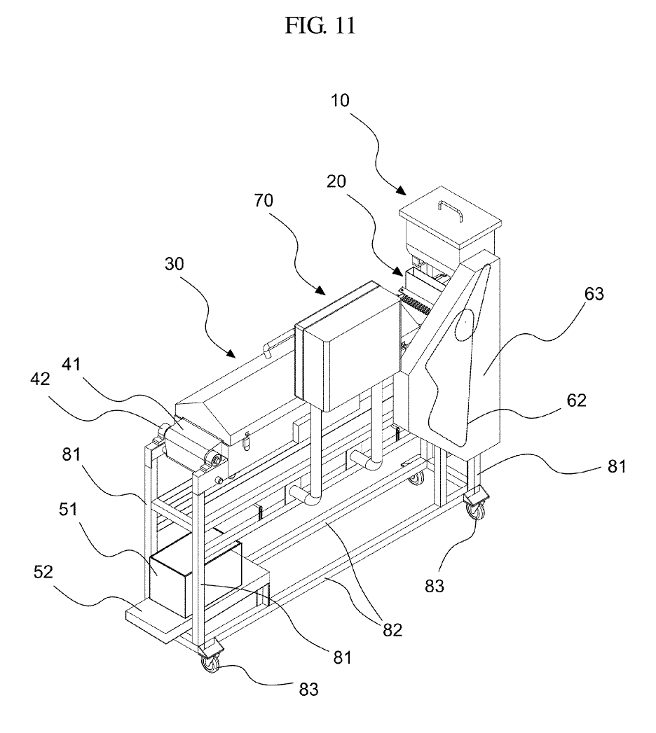

As shown in FIGS. 1 and 11, the rice noodle manufacturing apparatus of the present disclosure comprises a mixing unit (10) formed as a box having a hollow part therein for receiving a mixture containing rice flour and water and discharging a dough,

a noodle shaping unit (20) having a plurality of blades for shaping the discharged dough into a plurality of strands of noodle when the dough moves to the heating unit along the transfer belt (41),

a heating unit (30), which forms a box as a housing so that heat is not discharged to the outside of the box and heats the noodle in the inside of the box with steam when it passes through the box,

a transfer unit (40) for transferring the dough and the noodle passing through the mixing unit, noodle shaping unit and the heating unit to the point of dropping toward the following noodle collecting unit,

a noodle collecting unit (50) for collecting the dropped noodle after the transfer,

a power unit (60) having a motor (61) and a transmission unit (62),

a control unit (70) for controlling the operation of the power unit and the heat of the heating unit, and
a main body (80) for supporting all the components.

Since the rice noodle manufacturing apparatus according to the present disclosure is characterized in that the rice noodle is manufactured by using wet method not by dry method, the uncooked rice should be watered before put into this inventive apparatus. It is preferable to blend in a large amount of about 10 times as much as in the conventional rice noodle preparation method. After rice is milled by a millstone, water is added in a ratio of about 1:1 to the milled rice flour. The kneading of the mixture of the flour and water is performed not by the compression method, but by the method wherein the dough flows naturally through the apparatus while experiencing the heating and cooling process. When water is too much, the dough may flow down from the side of the transfer belt 41. If the water content is too small, it is difficult to maintain a constant thickness. Thus, it will be needed to pay attention to the ratio of the dough and water.

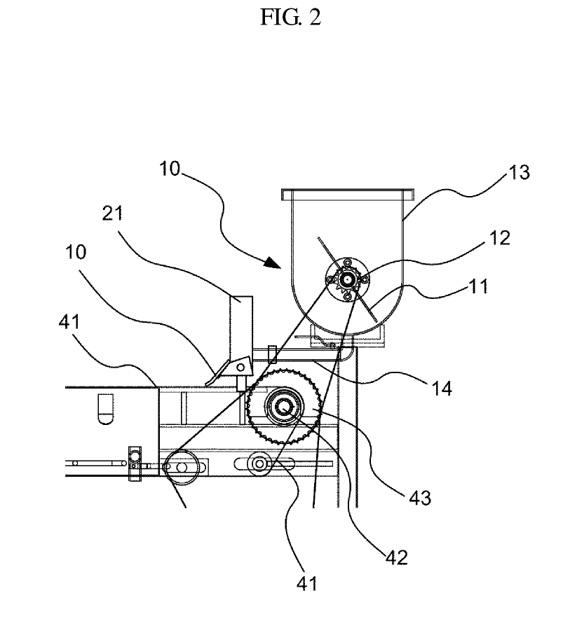

The mixing unit 10 according to the present disclosure should have a proper structure in order to prevent the precipitation phenomenon of the wet dough as well as to mix the rice flour and water suitably, and the detailed structure thereof is as shown in FIG. 2.

The mixing unit (10) includes a mixing vane (11) equipped in the hollow part and comprising a plate-shaped rotating wing and a rotating shaft, and a mixing gear (12) formed outside of the mixing vane (11) extending from the rotating shaft of the mixing vane, and receiving the power from the power transmission part.

As a hollow box for housing the dough, the bottom of the mixing box housing 13 is formed in a semicircular shape when viewed from the side for maximizing the rotation of the mixing vane 11 and the contact between the dough and the mixing vane 11. The mixing discharge unit 14 is to be connected to the dough supply port 211 of the dough dispenser 21 and then may be formed as a corresponding pipe member when the dough supply port 211 is in the form of a pipe.

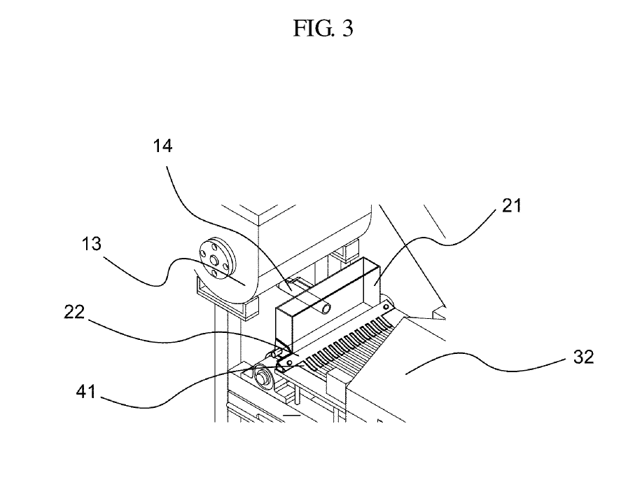

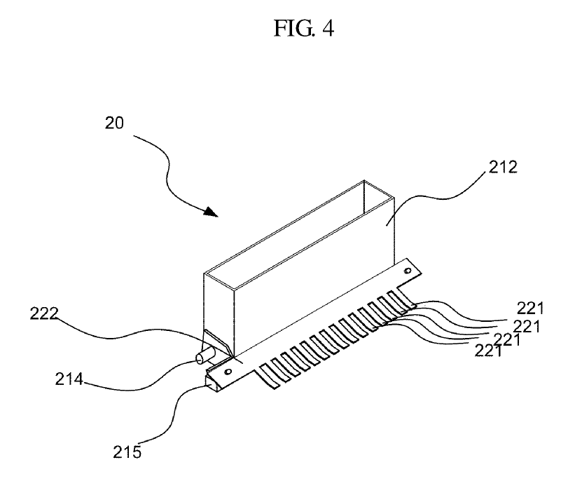

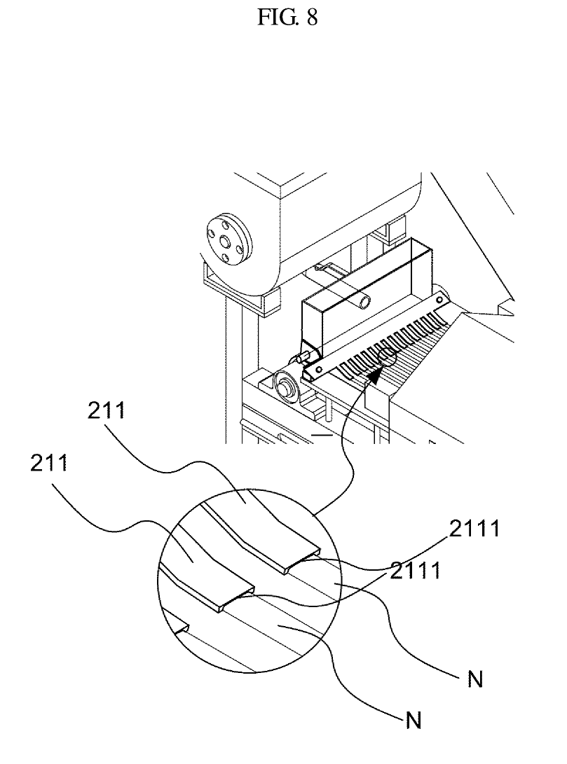

FIGS. 3 to 8 illustrate in detail the configuration and use state of the noodle shaping unit 20 according to the present disclosure. As shown in FIGS. 3 and 4, the noodle shaping unit 20 is composed of the dough dispenser 21 and the noodle shaping knife 22. The dough dispenser (21) temporarily holds a large amount of watery dough supplied from the mixing unit (10). As shown in FIG. 1, the rice noodle manufacturing apparatus of the present disclosure forms a plurality of strands of long and slim noodles (N) at the same time within the width of the transfer belt 41. As shown in FIG. 3, a small amount of dough is continuously discharged from the dough dispenser 21 onto the transfer belt 41 at regular intervals in the direction of width of the transfer belt, and the transfer belt 41 is continuously conveying the discharged dough so that a predetermined amount of the dough is passed through the noodle shaping knife 22 to make the noodle.

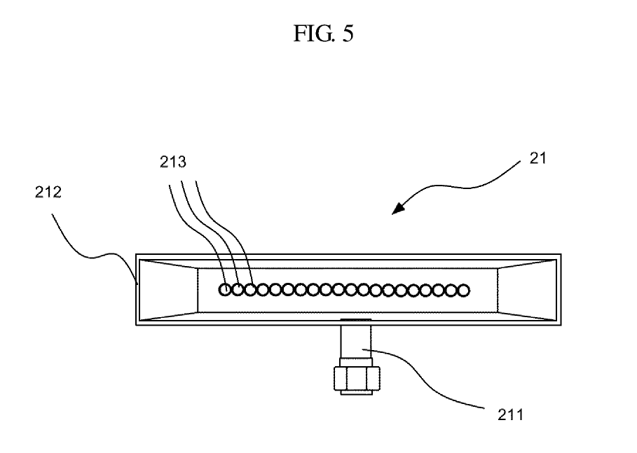

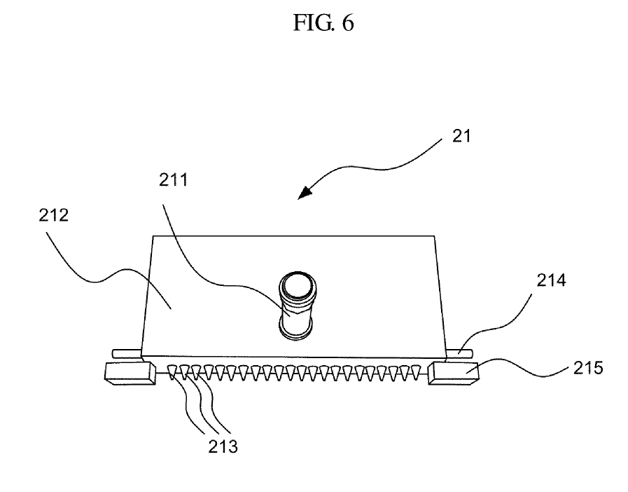

The dough dispenser 21 includes a dough supply port 211, a dough container 212, and a dispensing outlet 213 as shown in FIGS. 5 and 6 in order to perform the above-described series of processes. The dough supply port 211 is to be connected to the mixing discharge unit 14, and may be formed of a corresponding pipe member so that the mixing discharge unit 14 may be connected to a pipe type. The dough container 212 is formed in a hollow box shape to temporarily store the dough so that the dough can be supplied continuously without interruption until all the dough is dispensed to the dispensing outlets 213. The dispensing outlets 213 are formed as many as the number of strands of the noodles in a line in the width-direction of the transfer belt 41 as shown in the drawing. As shown in FIG. 6, the shape of the dispensing outlet is preferably a pointed conical shape, and the dough is continuously discharged at a given rate through the small holes formed at the end of the conical outlets.

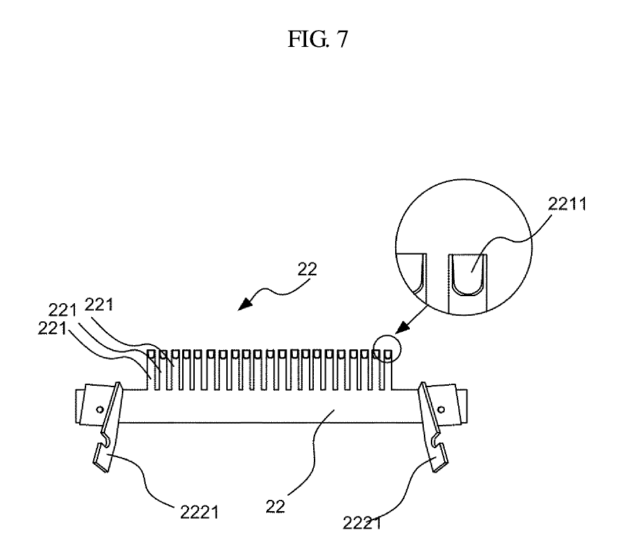

FIG. 7 is for showing the above-mentioned noodle-shaping knife 22 in detail, and is a view from the position of the transfer belt. A blade base 222 and a plurality of noodle-shaping blades 221 are formed like a comb. The main material is a kind of hard metal. The noodle shaping blades 221 make a thin flat noodle (N) during the process of the dough discharged from the dispensing outlet 213 being loaded on the transfer belt 41 and entering the heating unit 30. Therefore, the position of the blades 221 should be in a one-to-one correspondence with the distribution outlets 213 on the basis of the moving direction of the transfer belt 41. The blade base 222 supports the noodle shaping blades 221 and serves as a body for coupling with the dough dispenser 20. The noodle shaping blades 221 may include a shaping guide 2211 under the end portion thereof. This is to make the cross-section of the noodle into a desired, flat and smooth, shape, and the side of the noodle can be smoothly closed. In one embodiment, as shown in FIG. 7, the guide may be formed in the embossing form of ‘U’. The shape of the noodle may be varied by forming a suitable embossing in the shaping guide 2211 in order to make the cross section of the noodle to be processed a unique shape.

As shown in FIG. 6 and FIG. 7, the dough dispenser 21 is provided with blade holders 214 on both sides for rigid engagement with the noodle shaping blade 22, and the blade base 222 may have a blade fixing piece 2221. The dough dispenser 21 may have a dispenser pedestal (215) for maintaining a constant height.

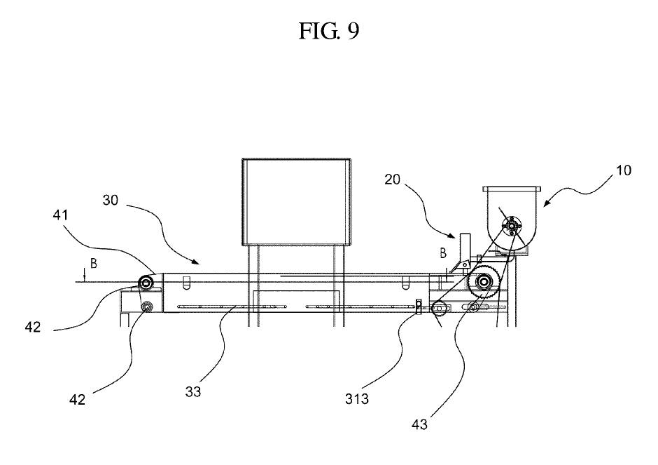

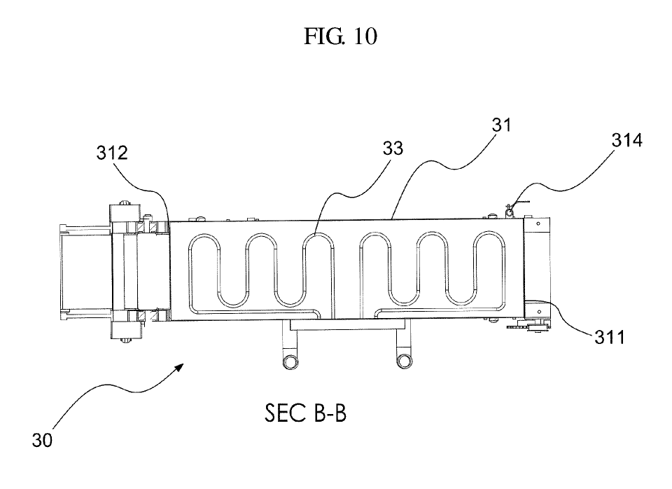

FIG. 9 is a side perspective view for explaining the structure of the heating unit 30 according to the present disclosure, and FIG. 10 is a plan cut view of the heating unit 30 taken along line B-B of FIG. 9. As shown in the figure, the heating unit 30 is configured to make a rice noodle having passed through the noodle shaping unit 20 by a steam to have a constant shape and a constant thickness of about 0.1 to 0.15 cm. It includes a heating unit housing 31 and a heating unit cover 32 to receive water for applying steam and to block the heat inside from the outside. As shown in the figure, a heating line 33 for brewing water is provided at an inner lower end of the heating unit housing 31, and is controlled by a switch operation of the control unit 70. The heating unit housing 31 surrounds the transfer unit 40. The inlet 311 and the outlet 312 are formed at both sides of the heating unit housing 31, which are larger than the width of the transfer belt 41 so that the belt can pass therethrough and so that the noodle on the transfer belt 41 can enter and exit. It is preferable that the height of the inlet 311 and the height of the outlet 312 are set low to minimize the leakage of steam.

In addition, the lower end of the heating unit housing 31 may further include a faucet-shaped water outlet 313 for discharging water and moisture from the housing and supplying new steam water.

As shown in FIGS. 1, 9 and 11, the transfer unit 40 according to the present disclosure adopts a conveyor belt system. Accordingly, there are equipped a transfer belt 41, which is thin and wide in width and connected to the end to form an endless track, and lots of transfer rollers 42 for tightening the transfer belt 41 to maintain tension. In addition, one of the transfer rollers 42 further includes a transfer gear 43 extending from the axis of the roller for receiving the power of the power transmission unit 62. It is preferable that the transmission gear 43 uses the axis of the transmission gear closer to the mixing unit 10 in consideration of the positions of the mixing unit 10 and the power transmission unit 62.

In addition, the transfer belt 41 may be made of various materials. However, in order to reduce the phenomenon of sticking to the noodle, the transfer belt 41 may be made of a Teflon material having low friction and excellent air permeability, or the surface of the belt may be coated by a Teflon material.

The rice noodle manufacturing apparatus according to the present disclosure includes a noodle collecting unit 50 for collecting processed noodles. As in the embodiment shown in FIG. 1, the noodle collecting part 50 may be constituted by a noodle collecting pedestal 52 and noodle baskets 51. The position of the noodle gathering baskets 51 should be positioned so that the noodles can be well received in the baskets when the noodles (N) fall at the dropping point of the end of the transfer belt 41. Therefore, it may be considered making a jaw on the noodle collecting pedestal 52.

The power unit 60 is equipped for providing rotational force to the mixing unit 10 and the transfer unit 40. As shown in FIG. 1 and FIG. 9, the power unit 60 includes a power motor 61 which is connected to the main body and making a rotational force, and a power transmission unit 62 which is made of a material such as a chain or a rubber belt and transmits the rotational force made from the power motor 61 to another position. The speed of the power motor 61 can be controlled by the control unit 70 in order to ensure sufficient time for shaping the noodle and applying steam.

FIG. 11 is a rear view of a rice noodle manufacturing apparatus according to the present disclosure. As shown in the figure, the main body 80 can be simply and robustly made of a steel frame. The main body 80 includes a plurality of struts 81 for supporting the apparatus in the longitudinal direction and a plurality of beams 82 for supporting the apparatus in the transverse direction. A plurality of casters 83 may be attached to the lower end of the main body 80 to facilitate movement of the apparatus.

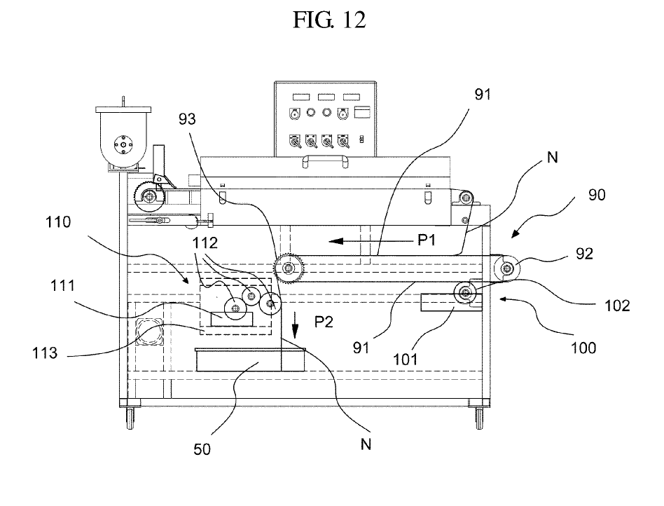

FIG. 12 is a view showing another embodiment including additional components in the rice noodle manufacturing apparatus according to the present disclosure. As shown in the figure, the apparatus of the present disclosure may further comprise a second transfer unit 90, which transfers the noodle falling from the transfer unit 40 in a direction (P1) opposite to the transfer direction of the transfer unit 40. The second transfer unit 90 is disposed at a lower portion of the transfer unit 40 and is configured by a conveyor belt system including a second transfer belt 91 and a second transfer roller 92. One end of the second transfer belt further comprises a second transmission gear (93) for extending the shaft of the roller to receive the power of the power unit. The noodles can be sufficiently cooled by the cooling fan or the like while they are being conveyed through the second transfer unit 90. As the dropping point of the noodle changes, differently from shown in FIGS. 1 and 11, the noodle collecting baskets 51 are installed in the center of the main body.

Of course, as with the transfer belt 41, the second transfer belt 91 may also be made of Teflon material and the surface contacting the noodle is coated with Teflon material.

In addition, for smooth noodle texture, the oil can be supplied to the noodle by applying an edible oil directly to the surface of the noodle with a brush, or by applying oil to the surface of the belt. However, the apparatus of the present disclosure, in order for supplying the edible oil more conveniently, comprises a belt oil supply unit 100 and the noodle oil supply unit 11 selectively or both, as shown in FIG. 12.

The belt oil supply unit 100 includes a belt oil chamber 101 provided below the second transfer belt and in the form of a bowl for storing oil, and a belt oil roller 102 provided between the second transfer belt and the belt oil supply unit for supplying oil to the lower surface of the second transfer belt while rotating. The belt oil rollers 102 should be installed so that the lower portion of the rollers can be contained in the edible oil accumulated in the belt oil chamber 101. Thus, every time the belt oil roller 102 rotates, the edible oil of the surface of the roller is transferred to the lower surface of the second transfer belt, and the oil is supplied to the noodle in the process of transferring. The belt oil roller can receive the power from the power unit by adding the power transmission gear or the like as the roller of the transfer unit.

The noodle oil supply unit 110 includes a noodle oil case 111 installed at a lower portion of the inner end of the second transfer unit 50 in the form of a bowl for receiving oil, and a noodle oil roller 112 installed between the noodle falling from the second transfer unit (50) and the noodle oil case (111) for supplying lubricated oil to the surface of the falling noodle while rotating. As shown in the drawing, the surface of the noodle oil roller 112 comes into contact with the surface of the dropping noodle. Since the noodle falls down vertically in the direction P2, it is difficult to configure the roller is installed only by a single roller contrary to the belt oil roller (102). Accordingly, as in the embodiment shown in FIG. 12, a plurality of rollers may be rotated by being brought into contact with each other to thereby transmit power and oil at the same time.

The scope of the present disclosure should not be construed as being limited by the above described embodiments, and the scope of the present disclosure is not limited to the claims but reach the equivalent scope to the claims.

The rice noodle manufacturing apparatus of the present disclosure not only improves the work force of the worker and increases the productivity by improving the cutting method, but also provides the consumers with the high viscosity and chewy texture of the rice noodle through the wet noodle processing method.

The rice noodle manufacturing apparatus of the present disclosure can make a great contribution to the noodle production industry as well as the noodle processing industry, and the spread of the rice noodle can greatly contribute to the development of the food industry by diversifying the consumers' preferences.

What is claimed is:

1. A rice noodle manufacturing apparatus comprising:
a mixing unit formed as a box having a hollow part therein for receiving a mixture containing rice flour and water and discharging a dough;
a noodle shaping unit having a plurality of blades for shaping the discharged dough into a plurality of strands of noodle when the dough moves to the heating unit along the transfer belt (41);
a heating unit, which forms a box as a housing so that heat is not discharged to the outside of the box and heats the noodle in the inside of the box with steam when it passes through the box;
a transfer unit for transferring the dough and the noodle passing through the mixing unit, noodle shaping unit and the heating unit to the point of dropping toward the following noodle collecting unit;
a noodle collecting unit for collecting the dropped noodle after the transfer;
a power unit having a motor (61) and a transmission unit (62);
a control unit for controlling the operation of the power unit and the heat of the heating unit; and
a main body (80) for supporting all the components.

2. The apparatus according to claim 1, wherein the mixing unit includes,
a mixing vane equipped in the hollow part for mixing the rice flour with water, and comprising a plate-shaped rotating wing and a rotating shaft;
a mixing gear formed outside of the mixing vane extending from the rotating shaft of the mixing vane, and receiving the power from the power unit; and
a mixing discharge unit formed at the lower end of the mixing housing for discharging the mixed dough toward the noodle shaping unit.

3. The apparatus according to claim 1, wherein the noodle shaping unit includes,
a dough dispenser comprised of a dough supply port, which is formed on the back surface to receive the dough and connected to the mixing discharge unit, a dough container, which receives the supplied dough, and a plurality of dispensing outlets, which are formed in parallel on the floor in order to distribute the dough in a plurality of strands; and
a noodle shaping knife for shaping the dough into a noodle during the transfer process, and the noodle shaping knife is coupled to the front surface of the dough dispenser and is comprised of a plurality of noodle shaping blades which are formed corresponding to the number and position of the dispensing outlets, and a blade base, which is for supporting the noodle shaping blades.

4. The apparatus according to claim 3, wherein the blades is formed with a shaping guide recessed in a U-shape when viewed from the bottom so that a cross section of the noodle can be gently formed at the lower end of the outer edge.

5. The apparatus according to claim 5, wherein the heating unit includes a heating unit housing and a heating unit cover to receive water for applying steam and to protect heat of the inside of the heating unit from the outside, and the heating unit housing is formed so as to surround the transfer unit and comprised of a noodle entrance port toward the mixing unit for entering the shaped noodle and the transfer belt, and a noodle discharge port for discharging the noodle in a direction opposite to the entrance, and a heating line is formed on the inner bottom of the heating unit housing 31.

6. The apparatus according to claim 5, wherein the heating unit housing 31 further include a water outlet at a lower end thereof.

7. The apparatus according to claim 1, wherein the transfer unit is constituted by a conveyor belt system including a transfer belt and a transfer roller, and one end of the transfer belt is extended by the axis of the roller so that a transmission gear is further formed for receiving the power of the power unit.

8. The apparatus according to claim 7, wherein the transfer belt is made of the Teflon material or its surface contacting the noodle is made of the Teflon-coated material.

9. The apparatus according to claim 1, wherein the power unit further includes a power transmission unit and a power transmission housing for receiving gears connected to the power transmission unit.

10. The apparatus according to claim 1, wherein the main body is made of a steel frame and includes a plurality of pillars for supporting the apparatus in the longitudinal direction, beams for supporting the apparatus in the transverse direction, and a caster at the bottom for moving the apparatus easily.

11. The apparatus according to claim 1, wherein the apparatus further includes a second transfer unit installed below the above transfer unit for transferring the dropped noodle in the opposite direction, which comprises a second transfer belt and a second transfer roller in a conveyer belt system, wherein the axis of the roller extends so that one end of the belt further includes a second transfer gear for receiving the power from the power unit.

12. The apparatus according to claim 11, wherein the second transfer belt is made of the Teflon material or its surface contacting the noodle is made of Teflon-coated material.

13. The apparatus according to claim 11, wherein the apparatus further comprises a belt oil supply unit, in which is provided below the second transfer belt and comprising a belt oil chamber 101 in the form of a bowl for receiving oil, and a belt oil roller installed between the belt and the belt oil chamber for supplying oil under the lower surface of the second transfer belt while rotating.

14. The apparatus according to claim 10, wherein the apparatus further includes the planetary oil supply unit which is installed below the inner end of the second transfer unit and includes a noodle oil chamber in the form of a bowl for receiving oil, and a noodle oil roller installed between the noodle falling from the second transfer part and the noodle oil case for applying oil to the surface of the falling surface while rotating.
